(19) United States
(12) Patent Application Publication
(10) Pub. No.: US 2010/0297328 A1
(43) Pub. Date: Nov. 25, 2010

(54) MARSHMALLOW-LIKE AERATED CONFECTIONERY AND METHOD OF PREPARATION THEREOF

(76) Inventors: Claude Capdepon, Chateauneuf de Gadagne (FR); Paul Stevens, Gent Mendonk (BE)

Correspondence Address: STITES & HARBISON PLLC, 1199 NORTH FAIRFAX STREET, SUITE 900, ALEXANDRIA, VA, 22314, US

(21) Appl. No.: 12/781,922

(22) Filed: May 18, 2010

(30) Foreign Application Priority Data
May 20, 2009 (EP) 09305469.0

(51) Int. Cl. A23G 3/52; A23G 3/42

(52) U.S. Cl. 426/571

(57) ABSTRACT

The present invention relates to a marshmallow-like aerated confectionery comprising a gelling agent and a non sweetening bulking agent, said bulking agent being in particular a sucrose and/or corn syrup substitute, a savoury flavour and said gelling agent being in particular a combination of gelatin and pectin.

The subject of the present invention is a marshmallow-like aerated confectionery, as well as its method of preparation.

Items of aerated confectionery are very popular foodstuffs. An example of aerated confectionery is the marshmallow. Marshmallows exist in different formats. The basic composition of marshmallows comprises water, a disaccharide such as sucrose, corn syrup, flavours and gelatin. It is also possible to incorporate flavours and colouring agents into this basic composition.

To prepare marshmallows, the sugars and corn syrup are mixed with the water and are heated to form a syrup having a high solids content. The syrup is then mixed with an aqueous dispersion of a colloid, and then whipped to obtain the desired volume by means of an expanding step. The colloid customarily used is gelatin.

Up till now existing commercial marshmallows are sweet, neutral to slight acid confectionery products. These consumer products are categorized as sugar confectionery and dedicated to children and adults to have a “sweet” moment of indulgence. Due to the neutral pH and the presence of sugars (sucrose and corn syrup) of this product only flavours such as vanilla are really compatible with this type of confectionery product. This limits the consumer market for this type of application.

The aim of the present invention is to provide an item of marshmallow-type aerated confectionery without mono- or disaccharides.

The aim of the present invention is to provide an item of marshmallow-type aerated confectionery with savoury flavour.

The aim of the invention is to produce an item of marshmallow-type aerated confectionery which targets the snack market and broadens by this way the application field of marshmallows. The consumption of these savoury marshmallows will focus an adult population and be proposed as an alternative snack while drinking an aperitif or having a beer in a bar or while looking at television or going to the movie.

The present invention thus relates to a marshmallow-like aerated confectionery comprising a gelling agent and a bulking agent.

The term “marshmallow” generally designates marsh mallow paste in the form of pastel-coloured cubes.

The name “marshmallow” and the nature of this confectionery come from a medicinal extract of the root of the Marsh Mallow (althae officinalis). Marshmallows are conventionally prepared by suspending in a sugar syrup a foam based in particular on colloidal matter.

The term “marshmallow-type aerated confectionery” usually designates a sweet or candy having a spongy, resilient consistency based on gelatin and sugar.

Then, the invention is based on the fact that the marshmallow of the invention is not sweetened and does contain neither sugar (sucrose, also called saccharose) nor sugar syrup (corn syrup) as usual marshmallows.

The term “gelling agent” designates a substance which is used to pass from a solution to a solid state. Said agent then results in the formation of a gel.

The term “bulking agent” designates non-nutritive or nutritive substances added to foods to increase the bulk and effecting or non-effecting satiety, which are especially used in foods designed for weight management.

In the present invention, the bulking agent is essentially non-sweetening and/or low sweetening. Fractions of standard sweeteners (sweetening power equal to sucrose/saccharose) can be used. The bulking agent is preferably polydextrose.

It should be mentioned here the following relative sweetness: sucrose/saccharose=1, xylitol=1, maltitol=0.9, lactitol=0.4, and polydextrose≦0.1.

Preferably, this bulking agent is non-sweetening.

Preferably, the bulking agent is a sucrose and/or corn syrup substitute, in particular chosen from the group consisting of polyols and fibres.

Among the polyols, xylitol, maltitol, lactitol, and mixtures thereof are preferably used. Lactitol is particularly preferred, as it has a lower sweetness capacity.

Preferably, the gelling agent is gelatin, or a combination of gelatin and other hydrocolloids such as pectin. Most preferably, the gelling agent is a combination of gelatine and pectin. Said combination advantageously allows a good release of the savoury flavour and promotes stabilization of the marshmallow-like aerated confectionery. The obtained confectionery has a lighter structure.

According to an advantageous embodiment, the gelatin has a bloom of 100 g to 350 g, especially 200 g to 300 g, and preferably 240 g to 260 g.

The gelling power of the gelatin is expressed as bloom value. The bloom (gel strength) is the maximum force measured during the penetration of a standardised cylinder 12.7 mm in diameter to a depth of 4 mm and at a speed of 0.5 to 1 mm/second into a 6.67% gel matured for 16 to 18 hours at 10° C. in a specific flask (JAOAC 31, 511 (1948); 52, 401 (1969) and 53, 386 (1970)).

The bloom also makes it possible to determine the gelatinous stability of the gelatin. The higher the bloom, the higher the gelling power of the gelatin.

According to an advantageous embodiment, the gelatin has a viscosity of 2.5 mPa·s. to 5 mPa·s, especially 3.0 to 4.5 mPa·s, and preferably 3.6 to 4.1 mPa·s.

The viscosity of the gelatin is defined by its dynamic viscosity when it is tested as a 6.67% solution in water at 60° C.

The viscosity of a 6.67% gelatin solution is determined at 60° C. by measuring the flow time of 100 ml of the solution through a standard pipette.

The marshmallow of the invention has been developed combining preferably gelatine with bulking agents (sugar substitutes) with very low sweetness in a well defined recipe and processed under specific conditions on a continuous pressure beater.

According to a preferred embodiment, the marshmallow-like aerated confectionery of the invention comprises as bulking agent at least one polyol and at least one fibre, as well as the gelling agent, which is preferably a combination of gelatin and pectin.

Thus, a preferred marshmallow of the invention is a marshmallow containing gelatin and pectin, as well as a polyol chosen from the group consisting of: xylitol, maltitol, lactitol, and mixtures thereof, and a fibre chosen from the group consisting of: polydextrose, inuline, and mixtures thereof. Polydextrose can advantageously be used as a fibre and/or a bulking agent. The fibre is preferably polydextrose, as its sweetness capacity is low. However, polydextrose is viscous and therefore hinders aeration of the confectionery. The polyol advantageously decreases the viscosity. Thus, the confectionery obtained by using a combination of polydextrose and of a polyol presents a proper aerated structure.

The present invention also relates to a marshmallow-like aerated confectionery as defined above, further comprising a salt, in particular chosen from the group consisting of: sodium chloride, potassium chloride, sodium glutamate, and mixtures thereof.

According to a most preferred embodiment, the marshmallow-like aerated confectionery of the invention are as defined above, and further comprise a savoury flavour, said savoury flavour being in particular chosen from the group consisting of: cheese, fish, vegetables, herbs, spices, meat and salting flavours, such as emmental, chilli, salmon, beacon, tomato, rosemary, and mixtures thereof.

The marshmallow-like aerated confectionery of the invention may also, if appropriate, comprise a colouring agent.

According to a preferred embodiment, the marshmallow-like aerated confectionery of the invention does not comprise sucrose/saccharose.

Preferably, the marshmallow of the invention is fat free, sugar free and low calorie.

An advantageous embodiment of the marshmallow-like aerated confectionery of the invention comprises:
from 2 to 6% by weight of gelling agent based on the total weight of the confectionery,
from 0 to 80%, preferably from 50 to 70%, by weight of fibre, such as polydextrose, based on the total weight of the confectionery,
from 0 to 80% by weight of polyol based on the total weight of the confectionery,
from 1 to 5% by weight of salt based on the total weight of the confectionery.

According to an advantageous embodiment, the marshmallow-like aerated confectionery according to invention has a density from 0.2 to 0.8.

Preferably, the composition of the marshmallow-type aerated confectionery of the invention does not include starch. In fact, within the framework of the invention, starch is used only for the dusting of the marshmallows at the end of the preparation process, i.e. for the packaging of the marshmallows. Thus, starch does not form part of the internal composition of the marshmallows.

The present invention also relates to a method of preparation of a marshmallow-like aerated confectionery as defined above, comprising the following steps:

a) a step of dissolving in water the gelling agent,

b) a step of dissolving in water the bulking agent, such as polydextrose, optionally a polyol, and if appropriate the salt as defined above, such as sodium chloride, potassium chloride, sodium glutamate, and mixtures thereof,

c) a step of mixing the mixtures as obtained in steps a) and b),

d) if necessary a step of adding a savoury flavour to the mixture of step c), to obtain an homogeneous mass, and

e) a step of producing the marshmallow-like aerated confectionery from said homogeneous mass.

According to an advantageous embodiment, the water of step a) is hot water at a temperature of from 40° C. to 100° C., preferably 80 to 90° C.

Preferably, the mixture of step a) is maintained for at least 10 minutes, preferably 30 minutes, at a temperature of at least 40° C., preferably 60° C.

According to a preferred embodiment, the mixture of step b) is cooked at a temperature sufficient to obtain a final total soluble solid content of the finished product (marshmallow) of at least 78%, preferably 82%.

Preferably, said cooked mixture is allowed to cool down at a temperature of not below 40° C., preferably 60° C.

If necessary, the method of the invention may also comprise a step of agitating, which follows step d), so as to obtain a homogeneous mass, which is then transferred to the hopper of a continuous pressure beater.

According to a preferred embodiment, the method of the invention comprises a final step of extrusion.

The present invention also relates to a marshmallow-like aerated confectionery as obtained according to the method as defined above.

### EXAMPLES

### Example 1

### Description of the Ingredients

Gelatin (Gelling Agent)

The gelatin used is Rousselot® 5000 ACP gelatin. It is an acid process gelatin extracted from pig skin for edible applications. It has a constant foam capacity and foam stability.

It has the following characteristics:

| Gel strength (bloom) | 240-260 g |
|---|---|
| Viscosity | 3.6-4.1 mPa · s |
| pH | 4.5-5.5 |

Polydextrose (Fibre)

The polydextrose is Litesse® ULTRA™ (IP grade) of DANISCO (white powder).

This powder is a sorbitol-terminated, randomly bonded condensation polymer of D-glucose with some bound sorbitol and a suitable acid.

It is very soluble in water (approximately 80 g/100 mL at 20° C.).

Xylitol (Polyol)

The xylitol used in the invention is Xylitol C from DANISCO.

It is a white crystalline powder with a mean particle size range of 0.4-0.6 mm.

It is very soluble in water (approximately 1.6 g/mL at 20° C.).

Monosodium L-Glutamate (Salt)

This salt is obtained from AJINOMOTO (Ajinomoto Foods Europe).

It is also called E621.

The protocols described below make it possible to obtain 100 kg of finished product.

Preparation of Extruded Marshmallows

4 kg of gelatin (5000 ACP) are dissolved into 8 kg of water to obtain a mixture (a). This mixture (a) is dissolved in hot water (80-90° C.) and maintained for 30 minutes at 60° C.

A mixture (b) is prepared by mixing: 67.5 kg of polydextrose, 9 kg of xylitol, 2 kg of NaCl, 0.3 kg of Na glutamate, and 26 kg of water.

This mixture (b) is cooked in an open vessel to a temperature of 110° C. Then, it is allowed to cool down to 100° C.

The mixtures (a) and (b) are then mixed and allowed to cool down to 60° C.

The following step consisted of adding the colouring agent(s) and the flavours and of agitating the whole until a homogeneous mass was obtained. Finally, the total mass obtained was transferred into the hopper of the continuous pressure beater (Mondomix type).

The equipment used has the following parameters:
inlet pressure: 7 bars
pressure mixing head: 2.4-3 bars (end/beginning)
counter pressure: 2.6-2.8 bars (end/beginning)
speed inlet pump: 30 rpm
speed mixing head: 600-1200 rpm (end/beginning)
air pressure: 25-57 mm (end/beginning)
temperature inlet: 72-82° C. (end/beginning)
temperature outlet: 21-57° C. (end/beginning)
temperature double wall (cold): 20° C.
temperature double wall (warm): 80° C.
density of extruded mass: 0.22-0.26

Packaging of the Extruded Marshmallow

After extrusion, the rope is stored at ambient temperature (20 to 25° C.) for 2 hours.

The rope is then cut and rolled in starch.

The samples are then packed in plastic bags and stored at ambient temperature (20 to 25° C.).

### Examples 2 to 13

The following table describes various preparations of marshmallows according to the invention. The preparation method is the same as the one described above for example 1.

The marshmallows of examples 2 to 13 are obtained with various gelling agents, polyols, fibres, salts and flavours as indicated in the following table:

| Example | Gelling agent | Fiber | Polyol | Salt | Flavor |
|---|---|---|---|---|---|
| 2 | 250 Pig Skin | polydextrose | xylitol | NaCl + Na | emmental |
| | gelatine | | | glutamate | |
| 3 | 250 Pig Skin | polydextrose | xylitol | NaCl + Na | chili |
| | gelatine | | | glutamate | |
| 4 | 250 Pig Skin | polydextrose | xylitol | NaCl + Na | goat |
| | gelatine | | | glutamate | cheese + pepper |
| 5 | 250 Pig Skin | polydextrose | lactitol | NaCl + Na | crispy porc |
| | gelatine | | | glutamate | |
| 6 | 250 Pig Skin | polydextrose | | NaCl + Na | goat cheese |
| | gelatine | | | glutamate | |
| 7 | 200 Lime Pig Bone | polydextrose | lactitol | NaCl + Na | goat cheese |
| | gelatine + Pectine | | | glutamate | |
| 8 | 200 Lime Pig Bone | polydextrose | lactitol | NaCl + Na | crispy porc |
| | gelatine + Pectine | | | glutamate | |
| 9 | 200 LimeBovine | polydextrose | lactitol | NaCl + Na | crispy porc |
| | Bone | | | glutamate | |
| | gelatine + Pectine | | | | |
| 10 | 200 LimeBovine | polydextrose | lactitol | NaCl + Na | smoked |
| | Bone | | | glutamate | salmon |
| | gelatine + Pectine | | | | |
| 11 | 200 LimeBovine | polydextrose | lactitol | NaCl + Na | peanut |
| | Bone | | | glutamate | |
| | gelatine + Pectine | | | | |
| 12 | 200 LimeBovine | polydextrose | lactitol | sub4salt ® | peanut |
| | Bone | | | | |
| | gelatine + Pectine | | | | |
| 13 | 200 LimeBovine | polydextrose | lactitol | sub4salt ® | red pepper |
| | Bone | | | | |
| | gelatine + Pectine | | | | |

‘sub4salt ®’ is a product from Jungbunzlauer, comprising sodium and potassium chloride as well as other additives, (it allows to reduce the content of sodium from 30 to 35%)
The gelatines mentioned above are obtained from Rousselot.
The pectine is Amid CS 025-A from Herbstreith & Fox (H&F).
The lactitol is from Danisco.

### Example 14

A marshmallow comprising (for 100 g):

4 g of Rousselot® G.U.B.E. (90% gelatin and 10% pectin)

9 g of lactitol (Danisco),

41 g of water (demineralised),

68.1 g of polydextrose Litesse Ultra (Danisco),

1.8 g of Sub4salt®,

flavor (Givaudan).

The marshmallow does not comprise any fat and sugar, as illustrated in the table below:

| Nutrition facts | For 100 g | |
|---|---|---|
| Energy | 104 | kcal |
| | 435 | kj |
| Protein | 3.2 | g |
| Carbohydrates | 5.75 | g |
| of which | | |
| Polyol | 5.40 | g |
| Sugar | 0 | |
| Fat | 0 | |
| Dietary fibers | 61.5 | g |
| Sodium | 0.45 | g |

Compared to traditional snacks, the obtained marshmallow has a reduced calorie content up to 84%.

| | Energy | | | | |
|---|---|---|---|---|---|
| | 26-kcal; | 130-kcal; | 158-kcal; | 149-kcal; | 96.5-kcal; |
| | 104-kJ | 543-kJ | 650-kJ | 618-kJ | 409-kJ |
| Protein (g) | 0.8 | 1.88 | 6.5 | 1.5 | 2.85 |
| Carbohydrates | 1.44 | 12.75 | 3.5 | 13 | 19.63 |
| (g) | | | | | |
| Fat (g) | 0 | 8 | 12.5 | 10 | 0.73 |
| Dietary fibers | 15.38 | 0.9 | 1.75 | 0.9 | 0.58 |
| (soluble) (g) | | | | | |
| Sodium (g) | 0.11 | 0.2 | 0.1 | 0.2 | 0.19 |

1. Marshmallow-like aerated confectionery comprising a gelling agent and polydextrose, wherein said confectionery does comprise neither sucrose nor corn syrup.

2. The marshmallow-like aerated confectionery according to claim 1, wherein the gelling agent is gelatin, or a combination of gelatin and other hydrocolloids.

3. The marshmallow-like aerated confectionery according to claim 1, comprising at least one polyol.

4. The marshmallow-like aerated confectionery according to claim 3, said polyol is chosen from the group consisting of: xylitol, maltitol, lactitol, and mixtures thereof.

5. The marshmallow-like aerated confectionery according to claim 1, further comprising a salt.

6. The marshmallow-like aerated confectionery according to claim 5, wherein the salt is chosen from the group consisting of: sodium chloride, potassium chloride, sodium glutamate, and mixtures thereof.

7. The marshmallow-like aerated confectionery according to claim 1, further comprising a savoury flavour.

8. The marshmallow-like aerated confectionery according to claim 7, wherein the savoury flavour is chosen from the group consisting of: cheese, fish, vegetables, herbs, spices, meat and salting flavours, such as emmental, chilli, salmon, beacon, tomato, rosemary, and mixtures thereof.

9. The marshmallow-like aerated confectionery according to claim 5, characterized in that it comprises:
from 2 to 6% by weight of gelling agent based on the total weight of the confectionery,
from 0 to 80% by weight of polydextrose based on the total weight of the confectionery,
from 0 to 80% by weight of polyol based on the total weight of the confectionery,
from 1 to 5% by weight of salt based on the total weight of the confectionery.

10. The marshmallow-like aerated confectionery according to claim 1, characterized in that it has a density from 0.2 to 0.8.

11. A method of preparation of a marshmallow-like aerated confectionery according to claim 1, comprising the following steps:
a) a step of dissolving in water the gelling agent,
b) a step of dissolving in water the polydextrose, optionally a polyol, and if appropriate the salt,
c) a step of mixing the mixtures as obtained in steps a) and b),
d) if necessary a step of adding a savoury flavour to the mixture of step c), to obtain an homogeneous mass, and
e) a step of producing the marshmallow-like aerated confectionery from said homogeneous mass.

12. The method of claim 11, wherein the water of step a) is hot water at a temperature of from 40° C. to 100° C.

13. The method of claim 11, wherein the mixture of step a) is maintained for at least 10 minutes at a temperature of at least 40° C.

14. The method of claims 11, wherein step d) is followed by a step of agitating so as to obtain a homogeneous mass, which is then transferred to the hopper of a continuous pressure beater.

15. The method claims 11, characterized in that it comprises a final step of extrusion.

16. A marshmallow-like aerated confectionery as obtained according to the method as defined in claim 11.
